(19) United States
(12) Patent Application Publication
(10) Pub. No.: US 2021/0258721 A1
(43) Pub. Date: Aug. 19, 2021

(54) SYSTEM AND METHOD FOR REMOTE INTERCOMMUNICATION AT POINTS OF ENTRY INTO BUILDINGS OR LIMITED AREAS AND FOR REMOTE MANAGEMENT AND CONTROL OF THE ENTRANCES

(71) Applicant: SEA S.P.A., Teramo (TE) (IT)

(72) Inventor: Fabrizio DI SAVERIO, Teramo (TE) (IT)

(21) Appl. No.: 17/166,896

(22) Filed: Feb. 3, 2021

(30) Foreign Application Priority Data
Feb. 14, 2020 (IT) 102020000003034

(51) Int. Cl. H04W 4/021; H04W 4/024

(52) U.S. Cl. CPC H04W 4/021; H04W 4/024

(57) ABSTRACT

A system and a method for establishing a communication between a person wishing to access a controlled access building or area, and an addressee of that building or area. An URL address made accessible to the person is read using a multimedia electronic device connected through the Internet with a remote server having a web page corresponding to the URL address, and to a database with telephone numbers of one or more addressees. The numbers are displayed on the multimedia electronic device and, once the desired number is selected, the server establishes a telephone call between the person and the number selected of a second multimedia electronic device possessed by the addressee. The addressee called verifies the identity of the person and sends a release code which allows the opening of a gate or entrance door of the building or area.

This application claims priority to Italian Patent Application 102020000003034 filed Feb. 14, 2020, the entirety of which is incorporated by reference herein.

### BACKGROUND OF THE INVENTION

This invention relates to the control of the accesses to delimited areas, both private and public, for access to which use is currently made of the classic bell, often with the aid of an intercom system possibly equipped with a video camera.

In particular, the invention relates to an electronic system for transmitting an Internet address (URL) and sending it through the Internet to the Internet address obtained on a server for managing a set of data for activating various possible actions resulting from the access request.

### SUMMARY OF THE INVENTION

Currently, access to a delimited place such as a home or a private area, a public building or other places to which access is not free, is obtained by a request by means of an acoustic signal, that is, the classic bell, or in cases with greater attention to security, is managed and controlled by an intercommunication unit (intercom), which allows verbal communication with the person requesting access and, as far as possible, checking their identity, before giving consent to access.

The most widespread intercommunication unit usually comprises one or more intercom devices, which allow communication with a station located close to the entrance, for example, of a building or private home.

In the external unit, installed outside the gate and/or the entrance door of the building, there is a microphone which transmits the voice message of the person who has rung the bell to a reproduction device situated inside the home, or the office, where there is a second microphone which allows a response to be sent and a conversation to be established with the person outside, so as to verify the identity and the intentions.

For this purpose, in many cases there is also a video camera for also capturing the image of the face of the person who has rung the bell, to allow persons who must allow the entrance to see at least the face of the person.

Thanks to this intercommunication between the outside and the inside, the person outside is allowed access by means of an electrical signal which enables the opening of the gate or the entrance door.

These very widespread systems generally comprise various components, of which at least one pushbutton panel, with the pushbuttons each associated with a respective apartment or an internal area, at least one external unit equipped with a microphone and a loudspeaker, installed close to the entrance to the building; an internal unit located in an apartment or in each apartment, a bell and a pushbutton for controlling the opening of the gate/door.

Obviously, an electrical power supply will be necessary and a system for opening the door or the gate, which, upon command, enable the opening of the door or the gate.

As can be well inferred, all these devices require suitable connections, generally wired, the connection of each single pushbutton to a relative acoustic indicator, and the external unit with the internal unit or, each time, with the corresponding internal unit between a plurality of internal units of the various apartments.

In the case of the presence of a video camera, the wiring is further complicated and the necessary devices are also more complex and bulky.

There are currently intercom communication systems on the market which can be controlled by a wired or even wireless intercom, which transmits the audio/video signal from the external station via wire or wirelessly towards a fixed, mobile or cordless telephone.

In any case, a power supply system is needed on the inner and outer positions, which, however, have problems in guaranteeing continuous operation, for example, in the case of an electric power failure.

Moreover, since the connection is made towards the unit inside the home, it will be possible to respond to the call only from that point.

In the case of a distance from the location point of the internal unit or absence it will not be possible to respond and allow access to the authorized person.

Solutions have also been proposed with only the external station, in which the communication is established to a mobile phone device using 3G or Wi-Fi data network, but it is always necessary to have an external station.

In all the cases mentioned above, if no response is given to the call and the access request, the owner of the home or the person managing and controlling the accesses would not have the possibility of knowing who has called or has requested access inside.

Moreover, inside the external position there are often the relays for activating the access, for example, for opening the door or the gate and, therefore, the security level is reduced due to the objective possibilities of tampering by malicious individuals.

This situation presents a very high risk for individuals who live alone, in particular the elderly, people with disabilities, but also families or the staff of offices or trading concerns where direct vision of those requesting access to them is not possible or difficult.

The aim of the invention is therefore to provide a system for management of the communication and control of the accesses which allows a communication to be set up without an intercom, with total management of the response to a caller and authorization to enter the property, all performed in a digital manner (by means of an application via the Internet).

Another aim of the invention is to provide a system which, exploiting the potential of Internet protocols, in particular those currently used in the home automation sector, such as the TCP/IP protocol, allows the exchange of information between a device held by an external user who requires access, for example, to a housing unit, and a device available to individuals who use the housing unit or own the housing unit and must manage the access.

Yet another aim of the invention is to provide a system in which it is possible to display details and coordinates of the owner and/or of the person who occupies the housing unit, in an extremely simple and practical manner.

The aims specified are substantially achieved by a system and a method for intercommunication with a building or a delimited area with controlled access, as illustrated in the appended claims.

### BRIEF DESCRIPTION OF THE DRAWINGS

Further features and advantages of the present invention are more apparent in the non-limiting description of a preferred embodiment of the above-mentioned system, as illustrated in the accompanying drawings, in which:

FIG. 1 is a general view of the system according to the invention, in a simplified block diagram;

FIG. 2 shows a detail of the system illustrated in FIG. 1.

### DESCRIPTION OF THE PREFERRED EMBODIMENTS

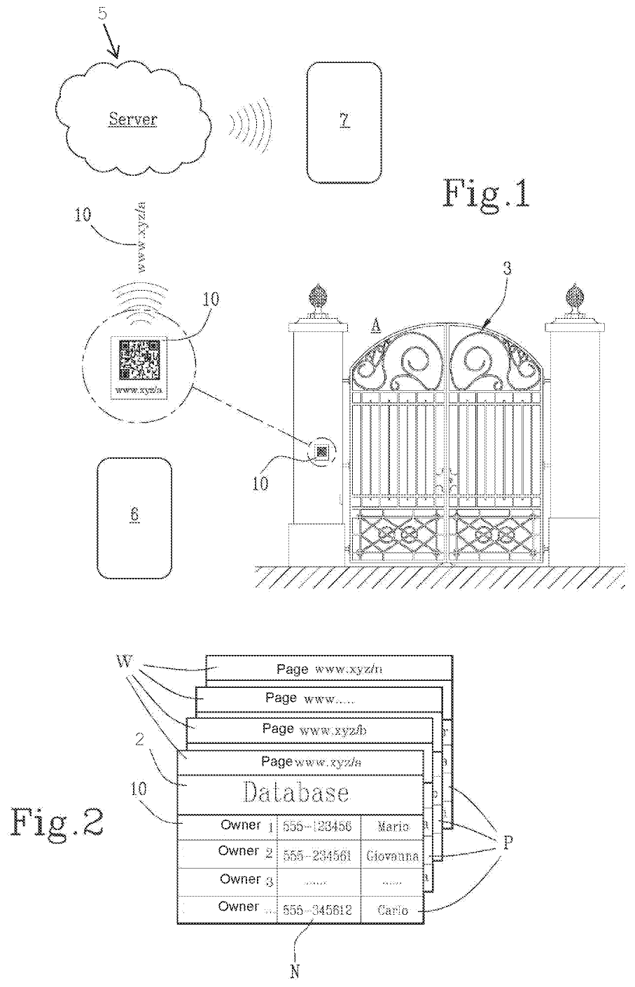

With reference to FIGS. 1 and 2, which show the intercommunication system according to the invention, which is described, for the sake of brevity and simplicity, only in terms of the essential parts, meaning that other components, materials or software, necessary for the correct and complete operation of the system will be considered present even though they are not described.

The numeral 10 denotes a URL address in a coded graphical (QR-code) or alphanumeric form, located near the means 3 for locking the controlled access to a building or a delimited area A, in such a way as to be visible and accessible from the outside.

Without constituting a limitation, in the example embodiment illustrated the locking means 3 consist of a gate, which provides access to an open area A, which may be a courtyard.

It should be noted that, according to a more general embodiment, the locking means 3 might, on the other hand, consist of an entrance door leading into a building, an office, a factory, a private club, a commercial area, a sports field, etc.

For simplicity, reference will be made below to a gate 3 which gives access to a garden A, without thereby limiting the sphere of application of the invention.

The graphical form of the URL address is represented by a two-dimensional code known as a QR-code, which is currently widely used, which contains all the information necessary to define it, but in a digital coded form. The alphanumeric representation, on the other hand, indicates the URL address in plain text, and can be simply acquired optically, or even reproduced manually on a keyboard.

The URL address, both in the encoded graphical form and in the plain text alphanumeric form, is reproduced on a label located, for example, on the post which supports one of the wings of the gate 3.

FIG. 1 shows both embodiments of the URL address, in order to provide example of both, but it should be understood that only one, the QR-code code or the alphanumeric representation, will be reproduced in reality on the label displayed.

Obviously, other positions are also possible, provided the code remains visible and accessible.

Protective means may be provided, if necessary, for example a removable or transparent cover, to prevent intentional or accidental damage to the support bearing the URL address and, besides a label, it is possible to use a card or a plate or other similar support.

The URL address 10 is detected by the person requesting access by means of a first multimedia electronic device 6 (in particular a first mobile electronic telephone device), generally consisting of a smartphone, but which may also be a tablet or other similar multimedia device, equipped with a camera which allows the acquisition of the code.

It should be noted that the person, without any need for specific applications, may through the first multimedia electronic device 6 be directed to the URL address 10.

In this case, it is possible to be directed in a particularly simple manner to the URL address 10: it is in fact sufficient to scan the URL 10 from (or manually enter in) the first multimedia electronic device 6 to be directed to the URL address 10.

In the case of the QR-code the software contained in the multimedia electronic device is able to decode the two-dimensional sequence of points and obtain the URL address.

In the simplest form which comprises the plain text display of the URL address 10, the multimedia electronic device must be equipped with optical character recognition software (OCR) which reconstructs the URL address in a digitalized form. It would also be possible to enter the smartphone, or other device, using the digital keypad reproduced on the touch screen.

A series of operating instructions (configured to be installed in the first mobile multimedia electronic device), part of which constitute a suitable “App” recorded in the first multimedia electronic device 6, or smartphone, controls the acquisition of the URL address 10 and after a suitable command connects the multimedia electronic device, by means of the Internet, or alternatively another geographical network, provided it is suitable for transmitting data, with a server 5, in which a series of web pages are made available, each corresponding to a URL address and designed to be selected upon receiving the corresponding URL detected by the multimedia electronic device 6.

In more detail, once the contact has been established between the first multimedia electronic device 6 and the server 5, the map of the zone is displayed on the screen of the smartphone, delimited on the basis of the geolocation system (GPS) or on the same URL address 10, with a graphical symbol set up at the entrance (on the map).

In order to activate the sequence of subsequent operations, it is therefore necessary that the person possessing the first multimedia electronic device 6 selects the graphical symbol, touching it on the touch screen.

The map of the zone may be defined by means of a suitable software, for example proprietary software, or by using existing mapping services, such as, for example, Google Maps.

For this reason, the map may be generated by an application present in the first multimedia electronic device 6 or by a remote server (and from these made available for displaying on the first multimedia electronic device 6).

It should be noted that this activation system makes it possible to operate even if the owner of the first multimedia electronic device 6 is not located close to the entrance of the building or the area to which access is requested.

In fact, it is possible to display the map with the information associated with the users who own the buildings even without the user being physically at the physical building.

In fact, the app resident on the multimedia electronic device may be able to obtain and show the graphical symbol corresponding to a predetermined building or a predetermined area when the user indicates the position on the map displayed on the touch screen of the multimedia electronic device 6, despite being in a different area.

When the web page corresponding to the URL address 10 is reached on the server 5, a web application program which is running locally, consisting of another part of the set of operating instructions, interrogates a database 2, resident on the server 5 and associated with the selected web page, to recover a series of telephone numbers N of one or more addressees P to which the building or the delimited area A refers, together with other addressees P of other buildings or areas, which have joined the service, for example by means of a suitable subscription.

This series of telephone numbers N of one or more addressees is then transmitted to the multimedia electronic device 6 and displayed on the screen of the latter, if necessary together with a list of corresponding names, in such a way as to allow the person requesting access to select one (indicating it, for example, on the touch screen).

It is also possible to display further information relative to the owner, or the list of owners, again in compliance with the privacy requirements, and therefore according to the limitations defined by the consent issued, as recorded in the database 2.

Once one of the numbers on the list present in the database 2 has been selected, the operating application on the server sets up a telephone call between the telephone number of the multimedia electronic device 6 connected with the server 5 and the telephone number N recovered in the database 2.

In this way, a virtual intercom service is created.

For this reason, the system puts in communication the first smartphone 6 with a second multimedia electronic device 7 (in particular a second mobile electronic telephone device), generally comprising a smartphone, but being able to also identify itself in a tablet or other similar multimedia device, designed to allow the communication, in possession of a addressee to which the building or the delimited area A refer, and identified by the name P recovered in the database 2.

In practice, it may be the owner of an apartment of the building, or a tenant of the building, or the doormen of a property, of a dealer located behind a sales counter who has no view of the entrance, or the employee of a factory, etc.

It should be noted that the communication established in this way can be carried out via the Internet, using a VoIP protocol, or by means of a GSM/GPRS telecommunication network.

At this point, the conversation, which until now has been carried out through the intercom apparatuses, takes place, on the other hand, by means of a normal telephone connection, with the elimination of the internal and external intercom stations, the relative wiring and relative power supplies.

Once the person requesting access has been recognized and it has been decided to allow access, the person requesting access telephonically can, if necessary, operate the normal pushbuttons for opening the gate 3, allowing access to the caller, if present.

Alternatively, a command can be activated, for example by pressing a pushbutton on the touch screen of the smartphone 7, and a release code transmitted, which allows opening of the gate 3 for entrance to the building or the delimited area A.

There may be various methods for sending and entering the release code.

It may be a code transmitted directly, after entering a password or other identification means, to a home automation control unit, using Wi-Fi or the Internet, which controls the opening of the gate 3, or it may be sent to the first smartphone 6, if necessary through the server 5 which records the sending, and transferred to the opening system of the gate by Bluetooth-tooth, or NFC.

In a simpler form, the release code may appear on the screen of the first smartphone 6 and the person can key it into an accessible keypad connected to the system for opening the gate 3.

In order to avoid an improper use of the release code, this may be regenerated each time and/or after a certain time, by means of a suitable algorithm also present inside the opening system of the gate 3, or transmitted to it in a suitable manner.

It should be noted that, if necessary, this system makes it possible to display the name, if registered in the address book of the second smartphone 7, or the telephone number of the person calling, before the recipient of the call responds, as is the case for normal telephone calls.

In this way it is possible to select whether or not to respond, and increase the security level. Malicious or unknown individuals can therefore be excluded from the moment of initial contact.

This communication system, since both the user and caller are connected to a web application program, could also advantageously allow, if it is necessary, the exchange of documents in an electronic format, digital signatures or the making of payments, without necessarily allowing access, or allowing access only to some delimited areas, for example the garden, the hallway where the mail boxes are located, etc.

Summing up, the method actuated by the system described to establish an intercommunication between a person wishing to access a building or a delimited area A, with controlled access, and an addressee P to which the building or the delimited area A refer, comprises preparing a URL address 10 in coded graphical form (QR-code) or alphanumeric form, made accessible from the outside near an entrance I, the preparation of a remote server 5, connected to the Internet and preparing a database 2 contained in the server 5 and provided with a series of web pages W with associated telephone numbers N (or other information) of one or more addressees P to which said building or delimited area A refers.

Each user P registered in the database 2 is assigned a URL address, which will then be applied close to the entrance I, in an accessible position, to be scanned by a caller who wishes to make contact with the user, by means of a first multimedia electronic device 6.

On the first multimedia electronic device, for example a smartphone, possessed by a person requesting access to the building or the area A, the app consisting of a part of the set of operating instructions prepared performs the detection of the URL address 10 and connects, by the Internet or another suitable geographical network, to the server 5.

Access to the server 5 may be allowed by means of a dialer of digital codes replicated on the site or by authentication with passwords or by reading fingerprints from the mobile phone or other caller identification tool.

Having established the contact between the first multimedia electronic device 6 and the server 5, the map of the zone, delimited on the basis of the geolocation system (GPS) or at the same URL address 10, is displayed on the screen of the smartphone with a graphical symbol prepared at the entrance, and the sequence of subsequent operations is activated by touching the touch screen.

The map of the zone, defined by a suitable software or by using Google Maps, makes it possible to operate even if the owner of the first multimedia electronic device 6 is not located close to the entrance of the building or the area of interest, indicating the desired position on the touch screen, where the graphical symbol corresponding to a predetermined building or a predetermined area will appear.

Once the graphical symbol has been activated, on the server 5, the application program comprising the remaining part of the operating instructions prepared identifies a web page, amongst the many contained, identified by the URL address 10 detected by the multimedia electronic device 6, which returns a series of telephone numbers N (or other information) of one or more addressees P to which the building or the delimited area A refers, contained in a database 2 together with other addressees P of other buildings or areas, which contributed to the service, for example by means of a suitable subscription.

This series of telephone numbers N of one or more addressees is then transmitted to the multimedia electronic device 6 and displayed on the screen of the latter, if necessary together with a list of corresponding names, in such a way as to allow the person requesting access to select one, indicating it on the touch screen.

At this point, the server 5 sets up a telephone call between the first multimedia electronic device 6 and a second multimedia electronic device 7, a smartphone, corresponding to the telephone number recovered in the database 2.

The recipient P of the call replies and recognizes the caller.

It is possible to provide or request the sending of further information, such as an image of the caller obtained by means of the camera of the first smartphone 6, or the name or telephone number of the caller, and it is possible to display further information relative to the owner, or the list of owners, again in accordance with the privacy requirements, and therefore according to the limitations permitted by the consent issued, as recorded in the database 2.

Alternatively, the QR-code or the alphanumeric form of the URL address are displayed on a display, located at the entrance I, from which the reading can be performed using the smartphone 6.

With the use of this invention, the owner of the apartment or area A towards which access is requested achieves the advantage of knowing who actually called or is calling, since the name or the number of caller is displayed on his/her smartphone, as in a normal telephone call.

The server 5 records both the data of the visitor calling and the owner user, also allowing a log of the calls and accesses allowed or denied to be interrogated with an access control function.

The same function may be achieved by means of a sensor identifying the visitor which can be read by the caller's mobile phone to make an automatic call to the user towards whom access is requested.

On the other hand, with regard to the owner of the system or the tenant of the apartment, or the dealer, etc, or his/her family, access may be allowed by typing in a code on a virtual keypad generated by scanning the QR-code, or by means of another protected authentication system, again operational on the smartphone, such as, for example, digital fingerprints which is already a function present on all the latest generation of mobile phones.

It should be noted that, since the external and internal unit are both replaced, respectively, by the QR-code or URL address, on which smartphones interact by both the caller and the receiver, the problem of the electricity supply is also resolved, since it is no longer necessary to wire the external and internal units with considerable savings in costs and also resolving the problem of possible power cuts.

Moreover, in the case of multi-users, the manager of the system and, therefore, of the APP or site would also have the possibility to handle multiple communications to all the owners of the property and also to be able to send condominium documents or various information, thus saving the time necessary for physical meetings.

Moreover, it would also be possible to forward the call, or at least a warning, to a second user indicated in the database. This function would prove particularly useful in the case of the elderly or people with disabilities, in which case the call would also be sent, or at least notified, to a relative who could check the identity of the caller and have news of the access request, with the obvious advantages in terms of greater security.

The use of a mapping service also makes it possible to establish the communication between the visitor and the owner even when the former is not close to the home or in general of the building of the latter. There may therefore be the presence of the recipient of the visit even during the route in order to reach the location or even being located only close to the home, safeguarding the person who is questioned.

According to the embodiments described, use of the Internet has been indicated but the invention may also be implemented using another geographical network suitable for data transmission.

The invention described makes it possible to achieve a total dematerialization of the intercom and the access control since the apparatuses necessary for this purpose are entirely replaced by a web application which reads an encrypted QR-code associated with the user and the communication signal is controlled on the Internet directly between caller and user mobile phones.

The proposed system is easy to install and is extremely safe and reliable for security purposes.

Both the external and the internal station could be eliminated and the user might also know not only that he/she has received a call but also from what caller code in the case of communication via common communications apps (for example “WhatsApp”, “Viber”, “Skype”, “WeChat”, etc.), with the advantage of a greater security.

With the proposed system, both managing the remote opening of an entrance and the communication between caller and called with authorization to enter the property occurs without an intercom, all performed in a digital manner and with an Internet application.

The communication occurs entirely between mobile devices belonging to the caller and the owner user, thanks to the use of the QR-code or URL address located close to the access.

It should be noted that the system is an “open” type system, that is to say, it is able to operate in the presence of any mobile device, even without it having a specific application installed.

It is sufficient for a user to scan the QR-code using the mobile device to be linked to the encoded URL and be able to display the information available there and perform any operations (call, etc.).

As is easy to imagine, the embodiments described may be made more complete and functional, associating a much higher number of possible operations to the same system.

All the other components, both in a physical state and in the form of software, necessary for the correct and complete operation of the system, which are not described here for reasons of simplicity and brevity, but whose presence or need will become evident to technicians in the trade, will need to be added to the various components described above.

What is claimed is:

1. An intercommunication system for a building or a delimited area with controlled access, comprising:
a support bearing a URL address made accessible from the outside close to an entrance to said building or delimited area, it being possible to detect the URL address by means of a first multimedia electronic device;
a series of operating instructions for displaying on said first multimedia electronic device a virtual map wherein a graphical element identifies, in said virtual map, a zone corresponding to said entrance and the association to it of said URL address;
a remote server, connected to the Internet or to another geographical network and designed to receive the call with said URL address from the multimedia electronic device and to provide at least one web page corresponding to said URL address;
a database resident on said server and containing a series of telephone numbers for displaying on said multimedia electronic device a list of said one or more addressees to which said building or delimited area in such a way as to allow one or more addressees to which said building or delimited area refer and set up a telephone call.

2. The system according to claim 1, wherein the URL address is displayed on a label in a coded graphical form, such as QR-codes, or in plain text in alphanumeric form, and can be detected by optical acquisition devices associated with said first multimedia electronic device.

3. The system according to claim 1, wherein said URL address can be detected remotely by means of said multimedia electronic device by telematic means, selecting a graphical element identified on the virtual map and corresponding to said desired entrance and recovering it from a corresponding list prepared on said server.

4. The system according to claim 1, wherein the telephone call between the telephone number of the first multimedia electronic device connected to said server and the telephone number recovered in said database and corresponding to one of the addressees to which the building or delimited area refer is performed by means of the Internet, by means of a Vol P protocol, or by means of a GSM/GPRS telecommunication network.

5. The system according to claim 1, wherein said series of instructions is in the form of an app which is able to display a list of names and is configured for selecting the telephone number to which said server sends the call.

6. The system according to claim 1, wherein said series of instructions is also configured to allow a release code to be sent which allows the opening of means for locking access to the building or delimited area.

7. The system according to claim 1, wherein the acquisition of said URL comprises the use of said first multimedia electronic device consisting of a smartphone, a tablet or other similar multimedia device, equipped with a camera for acquiring said URL address reproduced in a coded or alphanumeric graphical form, and the telephone call is sent to a second multimedia electronic device, also consisting of a smartphone, a tablet or other similar multimedia device, to which the telephone number recovered on the database corresponds.

8. The system according to claim 7, wherein said URL address is coded in the form of a QR-code on a label made accessible outside said entrance.

9. A method for establishing an intercommunication between a person wishing to access a building or a delimited area with controlled access, and at least one addressee to which said building or delimited area refers, comprising:
preparing at least one URL address in a coded graphical or alphanumeric form, made accessible from the outside close to an entrance to said building or delimited area;
the graphical or alphanumeric code may be detected and entered on the Internet or other geographical network;
preparing a remote server, connected to the Internet or to another geographical network and which can be directed through said URL address;
preparing a database contained in said remote server containing a series of web pages corresponding to different URL addresses and containing corresponding telephone numbers of one or more addressees of buildings or delimited areas;
the displaying on a first multimedia electronic device of a virtual map wherein a graphical element identifies, in said virtual map, an area corresponding to said entrance and the association to it of said URL address.

10. The method according to claim 9, wherein said URL is detected by means of said first multimedia electronic device with an image acquisition capacity and said telephone call is established with a second multimedia electronic device.

11. The method according to claim 9, wherein the intercommunication between said first multimedia electronic device and the telephone number recovered in said database is established on the Internet, by means of a VoIP protocol, or by means of a GSM/GPRS telecommunication network, in both cases with elimination of internal and external intercom stations.

12. The method according to claim 9, comprising a step of acquiring said URL address by means of a device for acquiring said first multimedia electronic device and a subsequent step, actuated by said first multimedia electronic device, of displaying the contents present to said URL address.
